(19) United States
(12) Patent Application Publication
(10) Pub. No.: US 2007/0230576 A1
(43) Pub. Date: Oct. 4, 2007

(54) Deriving Motion Detection Information From Motion-Vector-Search Type Video Encoders

(76) Inventors: Dror Heller, Jerusalem (IL); Yosef Rotman, Jerusalem (IL)

Correspondence Address: HENRY M. SINAI;(IP-PARTNERSHIP), P.O. BOX 669, RAANANA, 43350, IL

(21) Appl. No.: 10/572,597

(22) PCT Filed:
(86) PCT No.: PCT/IL04/00867

(30) Foreign Application Priority Data
Sep. 21, 2003 (IL) 158024

(51) Int. Cl. H04N 11/02

(52) U.S. Cl. 375/240.16

(57) ABSTRACT

A method and apparatus for detecting motion from a digital video stream using MPEG (Moving Picture Expert Group) compression is provided. The MPEG encoder abstracts the relevant video motion data from the digital video stream and estimates the amount of motion for each of the 16×16-pixel macro-block of a current image frame relative to the corresponding 16×16-pixel macro-block of an image reference frame and determines, from the estimated amount of motion, whether the current frame is a motion frame.

### FIELD OF THE INVENTION

The present invention relates to the field of video encoding in general and in particular to obtaining Video Motion Detection (VMD) from Motion-Vector-Search (MVS) video encoding.

### BACKGROUND OF THE INVENTION

Digital video is usually compressed and encoded before it is distributed. Generally, video encoding is based on Motion-Vector-Search (MVS) algorithms. These algorithms provide high image quality at lower bit-rate, enabling the distribution of the video stream over lower-bandwidth networks. Examples of such algorithms are MPEG-2, MPEG-4 and H.264.

Developments from these algorithms has led many applications and tools including Video Motion Detection (VMD), that is, the ability to use digital video for detecting motion in the field-of-view. VMD uses an algorithm that provides a motion detection sensor which is derived from the processing of the video images. Thus, motion detection data may be obtained from a digital surveillance system, for example.

Various attempts have been made to detect motion from a digital video recording using MPEG video compression. For example, US Patent Application Publication No: US 2003/0123551 to Kim performs motion detection by using a motion vector generated in the MPEG video compression process.

One of the disadvantages of these image processing algorithms is that they require a substantial amount of computing power. Reducing the computing power requirements would enable the adding of performance to existing systems and/or providing the same performance at a lower cost.

There is thus a need for a method which for deriving motion detection information without adding processing power.

### SUMMARY OF THE INVENTION

The present invention is directed to a method of adding a motion detection feature to existing motion-vector-search (MVS) based applications. The inventors have realized that by only utilizing the relevant data from the digital video stream which is needed for video motion detection, the VMD data may be calculated from MVS-based interim results instead of a full implementation of a VMD algorithm.

There is thus provided, according to an embodiment of the invention, a method for detecting motion from a digital video stream. The method includes the steps of:

inputting the digital video stream into an MPEG (Moving Picture Expert Group) encoder;

abstracting the relevant video motion detection data from the digital video stream;

estimating the amount of motion for each of the 16×16-pixel macro-block, from the abstracted video motion detection data, of a current image frame relative to the corresponding 16×16-pixel macro-block of an image reference frame; and

determining, from the estimated amount of motion, whether the current frame is a motion frame.

Furthermore, according to an embodiment of the invention, the step of estimating includes the steps of:

calculating the Sum of Absolute Differences (SAD) for each 16×16-pixel macro-block of the current image frame relative to image reference frame; and

placing the SAD values of every macro-block in a designated table.

Furthermore, according to an embodiment of the invention, SAD is defined as:

SAD16(xc,yc,xr,yr)=Σ_{i,j=0 . . . 16}|C_{xc+i,yc+j}−R_{xr+i,yr+j}|; where C is the current image and R is the reference image.

Furthermore, according to an embodiment of the invention, the method further includes the step of applying a weighting function to each cell of the table. The weighting function is defined as:
W(i,j)=MAX(0,ST(i,j)−Ktr+NUM_NBR(i,j)*Kn);

where ST(i,j) is the SAD table cell value, NUM_NBR is the number of it's non-zero members, Kn is a constant added per non-zero neighbor, and Ktr is a constant decremented from the cell.

Furthermore, according to an embodiment of the invention, the step of determining includes the steps of

summing the cells of the SAD table; and

if the accumulated number of motion clocks is larger than a pre-determined threshold value designating the current image frame as a motion frame.

Furthermore, according to an embodiment of the invention, the method further includes the step of calculating the Motion Vector (MV) for each of the 16×16-pixel macro-blocks of the image.

In addition, according to an embodiment of the invention, the method further includes the step of transferring the data associated with each of the motion frames together with the encoded video stream to a control center for further analysis.

Additionally, there is provided, according to an embodiment of the invention, apparatus for detecting motion from a digital video stream. The apparatus includes a motion estimator for receiving a digital video stream and abstracting the relevant data for video motion detection. The motion estimator includes a calculator for calculating the Sum of Absolute Differences (SAD) for each 16×16-pixel macro-block of the current image frame relative to corresponding 16×16-pixel macro-block of an image reference frame from the abstracted video motion detection data.

Furthermore, according to an embodiment of the invention, the apparatus further includes a tabular unit for compiling the calculate SAD values in tabular form, a weighting unit for applying a weighting function to each cell of the tabular unit, a summing unit for summing the weighted cells of the SAD table and a motion detector for determining whether the current image frame is to be designated as a motion frame.

Furthermore, according to an embodiment of the invention, the motion detector includes an accumulator for summing the number of motion clocks.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a schematic block diagram illustration of prior art video streaming application using MPEG video compression together with Video Motion Detection (VMD);

FIG. 2 is schematic block diagram illustration of the MPEG encoder of FIG. 1;

FIG. 3 is a schematic block diagram illustration of a video streaming application utilizing MPEG-4 video compression together with VMD, constructed and operative according to an embodiment of the invention;

FIG. 4 is a schematic block diagram illustration of MPEG-4 encoder of FIG. 3;

FIG. 5 is schematic block diagram illustration showing the integration of the MPEG-4 encoder of FIG. 3 together with VMD module according to an embodiment of the invention;

FIG. 6 is a schematic flow chart illustration of the method to determine motion detection from MPEG video compression; and

FIGS. 7A and 7B is an illustration of a 10×10 SAD (Sum of Absolute Differences) table calculated from the method of FIG. 6.

### DETAILED DESCRIPTION OF PREFERRED EMBODIMENTS

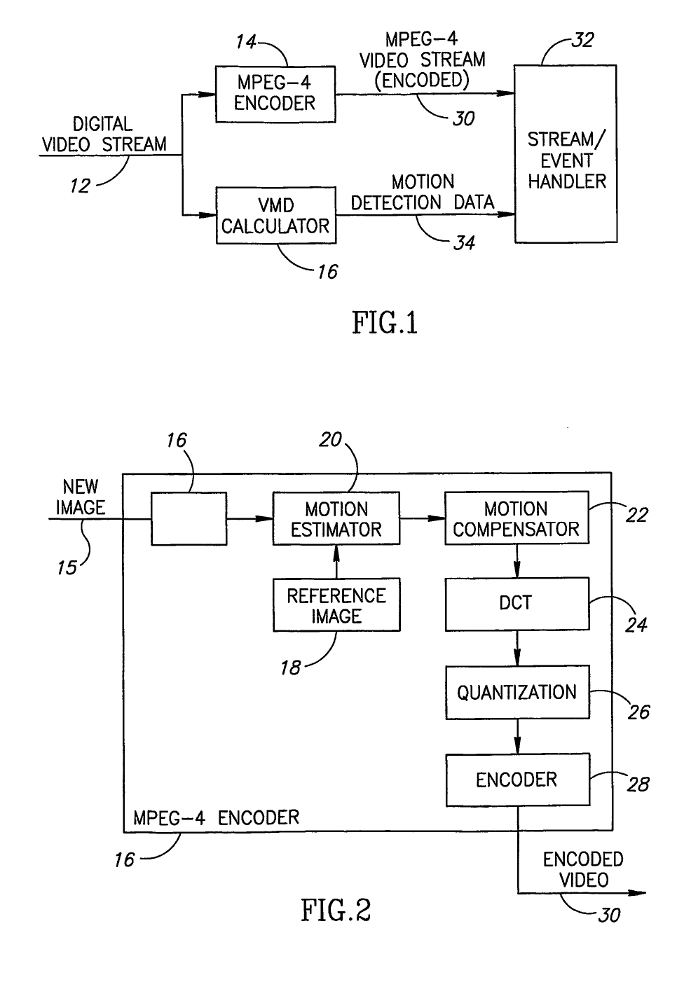

Reference is now made to FIGS. 1 and 2. FIG. 1 is a schematic bock diagram illustration of a prior art video streaming application using MPEG-4 (Moving Picture Expert Group) video compression together with Video Motion Detection (VMD). FIG. 2 is schematic block diagram illustration of the MPEG data processing flow.

The raw (uncompressed) video images 12 are input both to the MPEG (Moving Picture Expert Group) video compression encoder 14 and to the VMD calculator module 16.

FIG. 2 shows the data flow in a MPEG video streaming application. As is known in the art, a standard MPEG video compression device generally includes, inter alia, frame storage units 16 for the input image 15 and for the reference image 18, modules for motion estimation 20 and motion compensation 22.

Motion vectors are defined in the Moving Picture Expert Group (MPEG) standard specification. Briefly, when a digital image frame 15 is input, the motion estimation unit 20 estimates a motion vector on a macroblock by macroblock basis with reference to a reference image frame 18. The estimated motion vector is transmitted to the motion compensation unit 22, where an estimate of the movement of each macro block from the location of the current macro block is obtained.

In parallel, the forme storage unit stores the input image frame 15 in storage unit 16. The difference in value between the macro block of the input image frame and the estimated motion vector is compressed in the discrete cosine transform (DCT) unit 24 and the quantization unit 26. The compressed data are transformed into an MPEG stream in the encoding unit 28. The compressed data are restored and added to the motion compensated prediction data and stored in a reference frame storage unit 18 as a reference image frame for the next frame input. The encoded video stream 30 is sent to the stream/event handler 32.

The VMD calculator module 16 uses algorithms on the digital video stream to detect motion in the field-of-view and issue alerts whenever a pre-defined event (such as an intrusion) occurs. The motion detection data (alerts) 34 are also sent to the stream/event handler 32. Generally, the encoded video stream 30 and motion detection data (alerts) 34 are then sent to a control center (not shown) for decision making.

The inventors have realized that by only utilizing the relevant data from the digital video stream which is needed for video motion detection, the VMD data may be calculated from MVS-based interim results instead of a full implementation of a VMD algorithm.

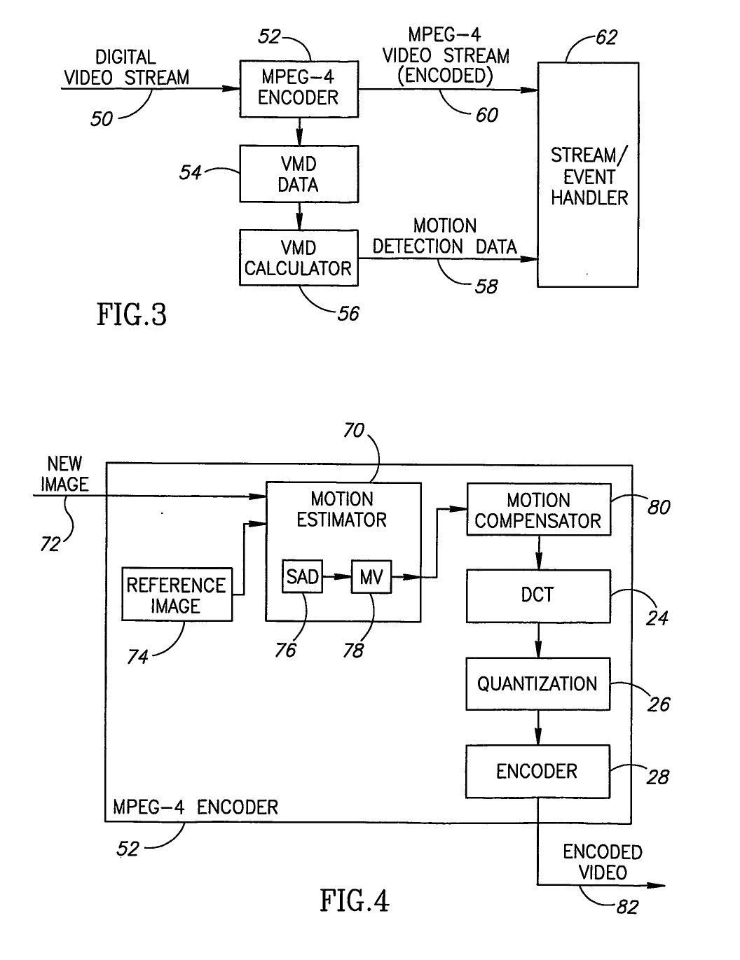

Reference is now made to FIG. 3, which is a schematic block diagram illustration of a video streaming application utilizing MPEG-4 video compression together with VMD, constructed and operative according to an embodiment of the invention.

The method uses the by products of the MVS encoding process to mathematically derive motion detection data. The method was successfully implemented on MPEG-4, currently the de-facto standard for streaming video compression. For the exemplary purposes only, reference is made to MPEG-4, but as will be appreciated by persons knowledgeable in the art, other compression standards may also be used.

The raw (uncompressed) video images 50 are input directly to the MPEG-4 encoder module 52. The relevant data needed for video motion detection is extracted from the digital video stream and transferred to the VMD module 54. The size of this data portion is approximately 1/256 of the size of a regular image. The SAD table is M/16×N/16 in size, and thus the size is (M×N)/256, compared with an M×N image for motion (the original image). The extracted data is the SAD table, which is a table of M/16×N/16 elements, where each element represents the SAD value of a known macrocell of 16×16 pixels.

The VMD calculator module 56 uses an algorithm (as will be discussed hereinbelow) on the VMD data 54 to detect motion in the field-of-view and issue alerts. Both the VMD motion detection (alerts) data 58 and the compressed video stream 60 are transferred to the stream/event handler 62 (similar to stream/event handler 32 in FIG. 1).

Reference is now made to FIG. 4, which is a schematic block diagram illustration of MPEG-4 encoder module 52. The motion estimation unit 70 estimates the amount of motion in every 16×16-pixel macro-block of the new (current) image 72 relative to the previous (reference) image 74.

In an embodiment of the invention, the motion estimation unit 70 calculates the SAD (Sum of Absolute Differences) 76, according to the following formula:
SAD16(xc,yc,xr,yr)=Σ_{i,j=0 . . . 16}|C_{xc+i,yc+j}−R_{xr+i,yr+j}| Equation 1

Where C is the current image and R is the previous reference image.

If xc=xr and yc=yr the two macro-blocks are in the same location. Otherwise, if xc≠Xr and yc≠yr, the two macro-blocks are in different locations.

The encoding process tries to find the best fit in the immediate area of the macro-block. When there is no motion, the best SAD occurs in the same location.

Whenever there is any motion, the best SAD will occur in another location. The motion estimation unit 70 finds the best match and then determines the Motion Vector (MV) 78, which describes the relocation vector from the previous location to the new one.

The motion estimation module performs the SAD and MV for every macro-block C(x,y) in the current image. The motion vectors (MVs) are passed to the motion compensation module 80 for further processing.

Compensation module 80 is similar to motion compensator 22 of FIG. 2. Similar elements have been similarly designated and are not described further. The difference in value between the macro block of the input image frame and the estimated motion vector is compressed in the discrete cosine transform (DCT) unit 24 and the quantization unit 26. The compressed data are transformed into an MPEG stream in the encoding unit 28. The compressed data are restored and added to the motion compensated prediction data and stored in a reference frame storage unit 74 as a reference image frame for the next frame input.

The process continues and eventually the encoded video stream 82 is created.

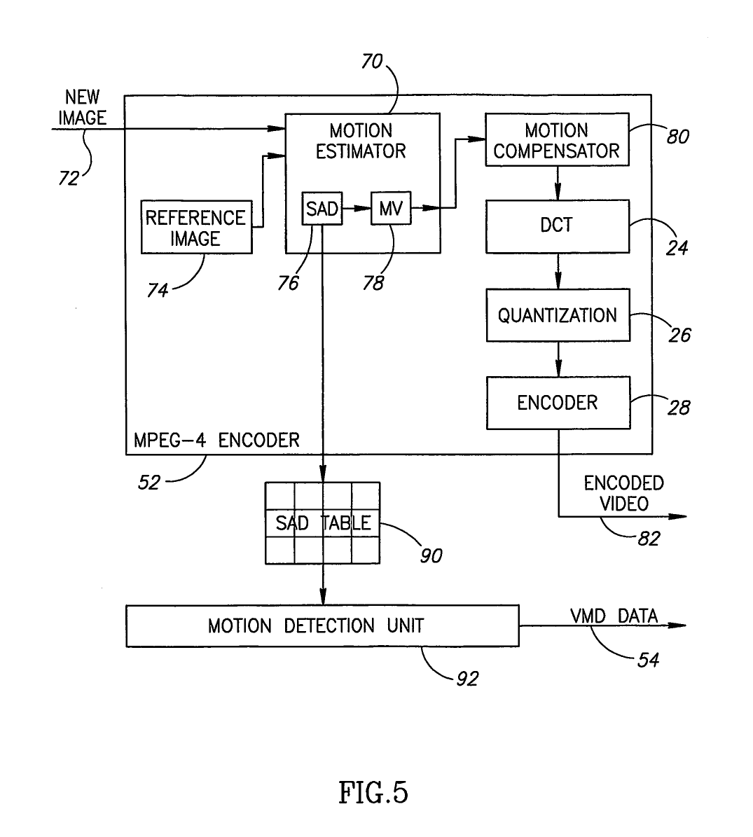

FIG. 5, to which reference is now made, is a schematic block diagram illustration showing the integration of the MPEG-4 encoder of FIG. 4 together with VMD module according to an embodiment of the invention.

FIG. 5 comprises the elements of FIG. 4 (which have been designated with similar numerals) and further comprises a SAD table 90.

The motion estimation module 70 places the SAD values of every macro-block in a designated table 90, and the table is then processed by the SAD module 92, to create the VMD data 54.

The VMD module 92 utilizes the SAD table 90 to determine the amount of motion in the complete current image 72, relative to the previous one 74.

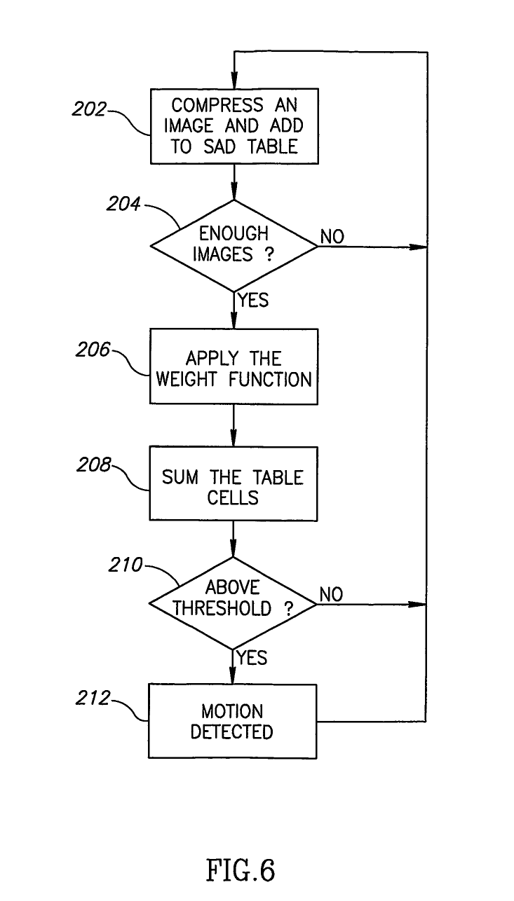

Reference is now made to FIG. 6, which is a schematic flow chart illustration of the method to determine motion detection. Each image is compressed and added to the SAD table (step 202). To minimize noise effects, the SAD table accumulates values over several frames. Since video is sampled at 25-30 frames per second, motion between one frame and the consecutive one should not be significant. A check is made after each image is compressed (query box 204) and further images are compressed and added to the SAD table until a pre-determined number of images have been processed.

To avoid irrelevant local image fluctuations, such as camera granularity and CCD quality, from appearing as movement, a weight function is applied (step 206) to emphasize the presence of large objects and minimize the effect of small isolated ones. This weight function intensifies the values of large blocks of non-zero values in the table by augmenting the cell values for every non-zero neighbor.

The weight function is defined below (Equation 2), where ST(i,j) is the SAD table cell value, NUM_NBR is the number of it's non-zero members, Kn is a constant added per non-zero neighbor, and Ktr is a constant decremented from the cell.
W(i,j)=MAX(0,ST(i,j)−Ktr+NUM_NBR(i,j)*Kn) Equation 2

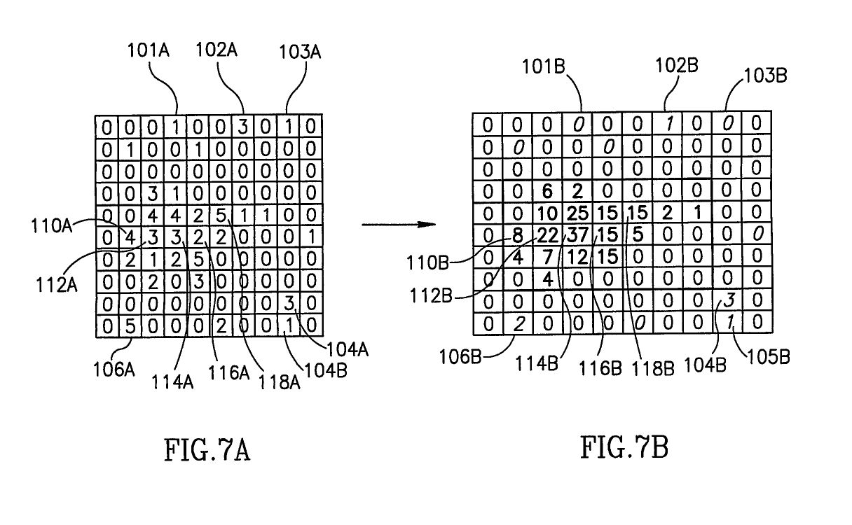

FIGS. 7A and 7B show a 10×10 SAD table that was produced using the above algorithm on a 160×160 stream of images, before and after weighting, respectively. FIG. 7A illustrates the SAD table before weighting while FIG. 7B illustrates the SAD table after the weight function has been applied.

The italicized cells in FIG. 7B (referenced 101B-106B) represent isolated instances of local movement that may be due to local noise and should not trigger a motion alarm. A comparison with the corresponding cells in FIG. 7A (referenced 101A-106A) shows that these cells were reduced significantly after the weight function was applied.

The bolded cells in FIG. 7B, bounded by the double line, illustrate cells where the weight function was augmented significantly. These cells probably represent an object in motion. Examples, for comparison purposes, are illustrated by the cells referenced 110-118 (suffixes A and B refer to FIGS. 7A and 7B, respectively). Thus, cell 10A having an initial value of 3 was increased to a value of 8 (cell 110B) after weighting. Similarly, the values of cells 112-118 were increased.

The examples are summarized in the table below:

| | | |
|---|---|---|
| | FIG. 7A- | FIG. 7B- value |
| Cell | Value | (after weighting) |

Noise affected cells:

| | | |
|---|---|---|
| 101 | 1 | 0 |
| 102 | 3 | 1 |
| 103 | 1 | 0 |
| 104 | 3 | 3 |
| 105 | 1 | 1 |
| 106 | 5 | 2 |

Motion Alert Cells:

| | | |
|---|---|---|
| 110 | 4 | 8 |
| 112 | 3 | 22 |
| 114 | 3 | 37 |
| 116 | 2 | 15 |
| 118 | 5 | 15 |

The table cells are then “summed” (step 208). Whether motion has occurred is determined from the summed cells of the processed table. This value is compared against a threshold for the existence of motion in the video stream (query box 210). If the value is above the alert threshold, a motion alert is triggered (step 212). It is thus possible to locate the main moving objects on this image and mark them.

The steps 202-212 are repeated for the rest of the video stream.

An advantage of the algorithm (equation 2) of the present application, over the prior art, is that the use of SAD algorithm allows slow motion to be detected. Motion vectors may record slow motion as 0, where the motion between one image to another is smaller than the motion detection resolution (i.e. where the motion estimation search jumps 8 pixels, and the motion speed is one pixel per image). In this case, the motion vector will be 0. In contrast, SAD values will be non-zero and, when accumulated, as described above, will detect the motion. In other words, there can be significant motion with zero motion vectors.

This feature may be demonstrated by the following example:

The motion estimation step is 8 pixels, and there is movement of 4 pixels per frame on average.

On a CIF image (320×240) at 30 frames per second a body that travels at that speed can traverse from top to bottom in 2 seconds (4 pixels by 30 frames per sec are 120 pixels per sec). Though this speed may be defined as “slow motion”, it is fast enough and significant enough to be considered motion, which should be detectable.

A further advantage of the above algorithm is that there is a significant saving in processing time. Thus, less powerful (and consequently cheaper) processors maybe use for the same tasks. Furthermore, a motion detection feature may be added to existing MVS-based applications with minimum added processing power. The calculation and processing power needed is between N×M/256 and N×M/100, instead of 2×N×M, where N and M are the width and height of the image respectively.

The above examples and description have of course been provided only for the purpose of illustration, and are not intended to limit the invention in any way. It will be appreciated that numerous modifications, all of which fall within the scope of the present invention, exist. Rather the scope of the invention is defined by the claims that follow:

We claim:

1. A method for detecting motion from a digital video stream comprising the steps of:
inputting the digital video stream into an MPEG (Moving Picture Expert Group) encoder;
abstracting the relevant video motion detection data from said digital video stream;
estimating the amount of motion for each of the 16×16-pixel macro-block, from said abstracted video motion detection data, of a current image frame relative to the corresponding 16×16-pixel macro-block of an image reference frame; and
determining, from the estimated amount of motion, whether the current frame is a motion frame.

2. The method according to claim 1, wherein said step of estimating comprises the steps of:
calculating the Sum of Absolute Differences (SAD) for each 16×16-pixel macro-block of the current image frame relative to image reference frame; and
placing the SAD values of every macro-block in a designated table.

3. The method according to claim 2, wherein said SAD is defined as:
SAD16(xc,yc,xr,yr)=Σ_{i,j=0 . . . 16}|C_{xc+i,yc+j}−R_{xr+i,yr+j}|;
where C is the current image and R is the reference image.

4. The method according to claim 2, further comprising the step of:
applying a weighting function to each cell of said table.

5. The method according to claim 4, wherein said weighting function is defined as:
W(i,j)=MAX(0,ST(i,j)−Ktr+NUM_NBR(i,j)*Kn);
where ST(i,j) is the SAD table cell value, NUM_NBR is the number of it's non-zero members, Kn is a constant added per non-zero neighbor, and Ktr is a constant decremented from the cell.

6. The method according to claim 4, wherein said step of determining comprises the steps of:
summing the cells of the SAD table; and
if the accumulated number of motion clocks is larger than a pre-determined threshold value designating said current image frame as a motion frame.

7. The method according to claim 1, further comprising the step of:
calculating the Motion Vector (MV) for each of the 16×16-pixel macro-blocks of said image.

8. The method according to claim 1, further comprising the step of:
transferring the data associated with each of the motion frames together with the encoded video stream to a control center for further analysis.

9. Apparatus for detecting motion from a digital video stream comprising:
a motion estimator for receiving a digital video stream and abstracting the relevant data for video motion detection, said motion estimator comprising a calculator for calculating the Sum of Absolute Differences (SAD) for each 16×16-pixel macro-block of the current image frame relative to corresponding 16×16-pixel macro-block of an image reference frame from said abstracted video motion detection data.

10. The apparatus according to claim 9, further comprising:
a tabular unit for compiling the calculate SAD values in tabular form;
a weighting unit for applying a weighting function to each cell of said tabular unit;
a summing unit for summing the weighted cells of the SAD table; and
a motion detector for determining whether the current image frame is to be designated as a motion frame.

11. The apparatus according to claim 10, wherein said motion detector comprises an accumulator for summing the number of motion clocks.
